(19) United States
(12) Patent Application Publication
(10) Pub. No.: US 2008/0019221 A1
(43) Pub. Date: Jan. 24, 2008

(54) Satellite travel audible narrator

(76) Inventor: Richard Freihofer, Parrish, FL (US)

Correspondence Address: Raymond M. Galasso;Galasso & Associates LP, P.O. Box 26503, Austin, TX, 78755-0503, US

(21) Appl. No.: 11/804,560

(22) Filed: May 18, 2007

Related U.S. Application Data
(60) Provisional application No. 60/801,987, filed on May 19, 2006.

(51) Int. Cl. H04B 1/20

(52) U.S. Cl. 369/1

(57) ABSTRACT

Satellite Travel Audible Narrator is a device for uploading mapping information for locations and playing audio files related to the locations. The preferred embodiment of the invention utilizes a housing with a Liquid Crystal Display (LCD) screen and transparent cover and a variety of control keys on the front, a head phone jack on the top and a digital audio storage and playback device and GPS technology in the interior. To use the preferred embodiment of Satellite Travel Audible Narrator, an individual would use the control buttons and the prompts on the LCD screen to select the manual or automatic playback of audio files in conjunction with the GPS system. If the device is set to automatic playback, the audio files indexed with a given point of interest automatically play upon arrival at the point of interest. If a given point of interest does not have any information stored as audio files, the closest point of interest having an audio file will be accessed and played. If the device is set for manual playback, the user will have the option of selecting a variety of audio files at any time. However, the various audio files associated with a given point of interest will automatically become available upon arrival at that point of interest. The various audio files will likely include information on geographical make-up and development, historical facts, landmark facts, agricultural information, attractions, hotels and restaurants for a given point of interest. If a given point of interest does not have any information stored as audio files, the closest point of interest having an audio file will become available. The GPS capabilities and audio storage and playback device are also available for stand-alone use. Hence, the GPS could be used purely as a navigational system and the audio storage and playback device can be used purely to play a user's music files. Headphones can be connected to the headphone jack if the user desires.

### CROSS REFERENCE TO RELATED APPLICATIONS

This United States Non-Provisional Patent Application claims priority to U.S. Provisional Patent Application No. 60/801,987 entitled “Satellite Travel Audible Narrator” filed on May 19, 2006.

### FIELD OF THE DISCLOSURE

The disclosures made herein relate generally to the vehicle and personal navigation and digital file industries. The invention discussed herein is in the general classification of Global Positioning Systems (GPS) and digital audio storage and playback devices.

### BACKGROUND

Global Positioning Systems (GPS) are increasingly popular as vehicle accessories and handheld devices. Many devices make use of a GPS to upload tailored mapping software with preprogrammed points of interest. GPS satellites transmit signals to equipment on the ground. GPS receivers passively receive satellite signals. GPS operations depend on a very accurate time reference, which is provided by atomic clocks at the U.S. Naval Observatory. Each GPS satellite has atomic clocks on board. Each GPS satellite transmits data that indicates its location and the current time. All GPS satellites synchronize operations so that these repeating signals are transmitted at the same instant. The signals, moving at the speed of light, arrive at a GPS receiver at slightly different times because some satellites are farther away than others. The distance to the GPS satellites can be determined by estimating the amount of time it takes for their signals to reach the receiver. When the receiver estimates the distance to at least four GPS satellites, it can calculate its position in three dimensions.

Digital audio storage and playback devices are also popular for storing audio data files, including the favorite music of a user. The MP3 player is one of the most recent in an evolution of music formats that has helped consumers enjoy their tunes. None of the earlier music formats such as records, eight-track tapes, cassette tapes and CD's provided the convenience and control that MP3 players give music lovers. With an MP3 player in hand or pocket, a consumer can create personalized music lists and carry thousands of songs wherever they go. The MP3 format is a compression system for music. The MP3 format helps reduce the number of bytes in a song without dramatically hurting the quality of the song's sound. The goal of the MP3 format is to compress a CD-quality song by a factor of 10 to 14 without noticeably affecting the CD-quality sound. With MP3, a 32-megabyte (MB) song on a CD compresses down to about 3 MB. This lets a user download a song in minutes rather than hours, and store hundreds of songs on a computer's hard disk without taking up that much space. Digital audio storage and playback devices can also be used to store other types of audio data files, including information regarding a given point of interest.

Often a user of a GPS-type device would like to obtain geographical, historical, landmark, hotel or restaurant information related to a given location once it is reached. Currently, there is no GPS-type device that incorporates the mapping software for points of interest with a digital audio storage and playback device that can give desired information about the locations.

Hence, there is a need in the art for a convenient to use, inexpensive, durable, safe and effective device for uploading mapping information for locations and playing audio files related to the locations.

### SUMMARY OF THE DISCLOSURE

Satellite Travel Audible Narrator is a device for uploading mapping information for locations and playing audio files related to the locations. It can be a handheld device or mounted or installed into the console of a car, boat, plane or other vehicle.

The preferred embodiment of the invention utilizes a housing with a Liquid Crystal Display (LCD) screen and transparent cover and a variety of control keys on the front, a head phone jack on the top and a digital audio storage and playback device and GPS technology in the interior.

The principal object of this invention is to provide a device for uploading mapping information for locations and playing audio files related to the locations.

Another object of this invention is to provide a device that can function as a GPS-type device without using any audio files.

Another object of this invention is to provide a device that can function as a digital audio storage and playback device of a user's music even when the GPS technology is not in use.

Another object of this invention is to provide an affordable device for uploading mapping information for locations and playing audio files related to the locations.

Another object of this invention is to provide an easily used device for uploading mapping information for locations and playing audio files related to the locations.

Another object of this invention is to provide a reliable device for uploading mapping information for locations and playing audio files related to the locations.

Yet another object of this invention is to provide a durable device for uploading mapping information for locations and playing audio files related to the locations.

### BRIEF DESCRIPTION OF THE DRAWINGS

FIG. 1 depicts a perspective view of the preferred embodiment of the present invention.

FIG. 2 depicts an overhead view of the preferred embodiment of the present invention.

### DETAILED DESCRIPTION OF THE DRAWINGS

The preferred embodiment of Satellite Travel Audible Narrator is comprised of at least some of the following: a housing with a Liquid Crystal Display (LCD) screen and transparent cover and a variety of control keys on the front, a head phone jack on the top and a digital audio storage and playback device and GPS technology in the interior.

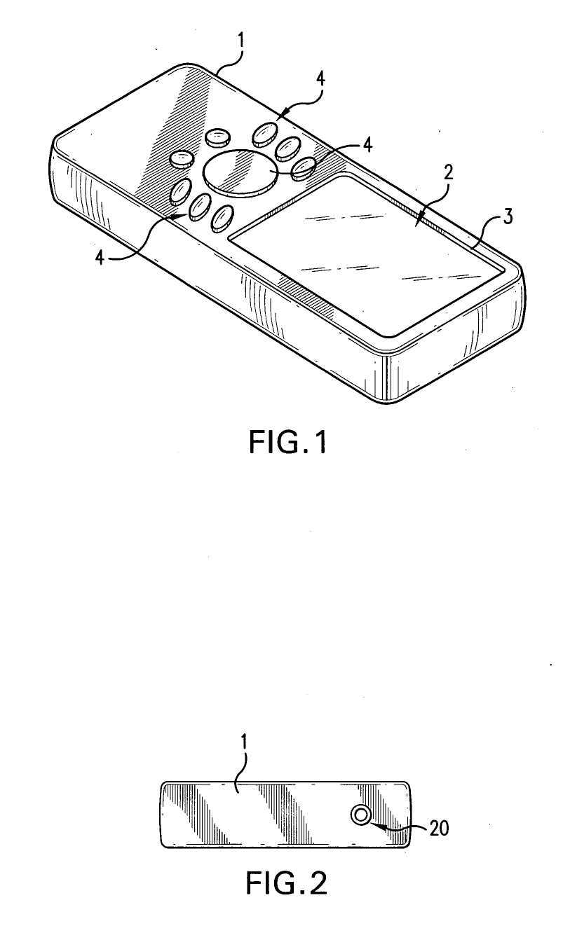

FIG. 1 depicts a perspective view of the preferred embodiment of the present invention. A housing 1 contains a digital audio storage and playback device and GPS technology as known in the respective fields of art. The housing 1 has a display screen 2 for providing prompts, directions, song titles and other information. The display screen 2 is an LCD in this preferred embodiment although other types of display screens would also work. A cover 3 is located on top of the display screen 2 for protection. The cover 3 is transparent and made of plastic in this preferred embodiment though a translucent screen or a screen made of glass or other materials would also suffice.

The housing 1 is approximately rectangular and made of plastic in this preferred embodiment. A variety of other shapes and materials could also be used for the housing 1. Although the exact size of the housing is not critical, the housing 1 is six inches in length, three inches in width and one inch in thickness in this preferred embodiment. The display screen 2 and the cover 3 are approximately rectangular and three inches in length and two and a half inches in width in this preferred embodiment.

Control keys 4 are located on the front and toward the bottom of the housing 1. The control keys 4 are used to control the GPS technology and the digital audio storage and playback device within the housing 1. In certain embodiments, one of the control keys will be labeled “Where Am I Now” and will cause the device to play back the audio file associated with a user's current location or the closest point of interest to the current location.

FIG. 2 depicts an overhead view of the preferred embodiment of the present invention. The top of the housing 1 can be seen in greater detail. The top of the housing 1 is approximately rectangular and made of plastic. The top of the housing 1 is three inches across and one inch in thickness. A head phone jack 20 is located toward one end of the top of the housing 1 to allow a user to use head phones when desired.

To use the preferred embodiment of Satellite Travel Audible Narrator, an individual would either mount the device in the console of his car or other vehicle or utilize it as a handheld device. An individual would use the control buttons and the prompts on the LCD screen to select the manual or automatic playback of audio files in conjunction with the GPS system. If the device is set to automatic playback, the audio files indexed with a given point of interest automatically play upon arrival at the point of interest. If a given point of interest does not have any information stored as audio files, the closest point of interest having an audio file will be accessed and played.

If the device is set for manual playback, the user will have the option of selecting a variety of audio files at any time. However, the various audio files associated with a given point of interest will automatically become available upon arrival at that point of interest. The various audio files will likely include information on geographical make-up and development, historical facts, landmark facts, agricultural information, attractions, hotels and restaurants for a given point of interest. If a given point of interest does not have any information stored as audio files, the closest point of interest having an audio file will become available.

The GPS capabilities and audio storage and playback device are also available for stand-alone use. Hence, the GPS could be used purely as a navigational system and the audio storage and playback device can be used purely to play a user's music files. Headphones can be connected to the headphone jack if the user desires.

The materials utilized for Satellite Travel Audible Narrator may vary widely but will likely include metal, plastic and electronic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Satellite Travel Audible Narrator can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An audio and directional device comprising:
(a) a housing containing a digital audio storage and playback device and a global positioning system receiver; and
(b) a display screen on the front of the housing with a plurality of control keys also located on the front of the housing.

2. The device of claim 1 wherein the digital audio storage and playback device is capable of storing and playing an audio file related to a given point of interest found by the global positioning system receiver.

3. The device of claim 1 wherein the housing is made of plastic

4. The device of claim 1 wherein the housing is approximately rectangular.

5. The device of claim 1 wherein the display screen is an LCD.

6. The device of claim 5 further comprising
a cover located on top of the display screen.

7. The device of claim 6 wherein the cover is transparent.

8. The device of claim 6 wherein the display screen and cover are approximately rectangular.

9. The device of claim 1 further comprising
a head phone jack located on the housing.

10. An audio and directional device comprising:
(a) a housing containing a digital audio storage and playback device and a global positioning system receiver wherein the digital audio storage and playback device is capable of storing and playing an audio file related to a given point of interest found by the global positioning system receiver;
(b) an LCD display screen on the front of the housing with a plurality of control keys also located on the front of the housing;
(c) a transparent cover located over the LCD display screen; and
(d) a head phone jack located on top of the housing.

11. The device of claim 10 wherein the digital audio storage playback device automatically plays the audio file related to the given point of interest found by the global positioning system receiver upon arrival at the given point of interest.
